(19) United States
(12) Patent Application Publication
(10) Pub. No.: US 2002/0143712 A1
(43) Pub. Date: Oct. 3, 2002

(54) Process for mediating price information, system for implementing thereof and computer readable medium storing program for implementing price mediating process

(75) Inventor: Jun Suzuki, Kawasaki (JP)

Correspondence Address: STAAS & HALSEY LLP, 700 11TH STREET, NW, SUITE 500, WASHINGTON, DC, 20001, US

(73) Assignee: FUJITSU LIMITED, KAWASAKI-SHI (JP)

(21) Appl. No.: 09/942,912

(22) Filed: Aug. 31, 2001

(30) Foreign Application Priority Data
Mar. 30, 2001 (JP) 2001-102265

(51) Int. Cl. G06F 17/00

(52) U.S. Cl. 705/400

(57) ABSTRACT

The present invention relates to a price information mediating process for providing selling price information of at least one product supplier to at least one user. The process includes the steps of: receiving product search conditions from the user; retrieving a normal selling price of a desired product from storage means in accordance with the product search condition from the user, the storage means including normal selling price information which have been pre-registered by the product supplier; sending the retrieved normal selling price to the user; receiving a desired purchasing price presented by the user; and sending the desired purchasing price to the product supplier.

### BACKGROUND OF THE INVENTION

1. Field of the Invention

The present invention relates to a price information mediating service offered via a product price information provider site on the Internet.

2. Description of the Related Art

In the field of electronic commerce, information such as product inquiry information and selling price information are offered to users via network trading sites. For example, in case where a user wishes to search for a certain product on the trading site, a search is performed according to search conditions set by the user, and the result is displayed as a list including data related to product suppliers wherefrom the desired product is available, selling prices and privileges. The user selects the most preferable product supplier from the displayed list and submits a purchasing instruction. The desired product is ordered in accordance with this instruction, and the desired product is delivered to the user.

With the above-described conventional service, the user can obtain information related to a selling price of each product supplier. However, it is not possible for the product suppliers to know at what price the user wishes to purchase the product. That is to say, the product supplier only sets the selling price he/she is thinking of and presents the selling price to the users, but does not truly know the price the user considers reasonable.

Also, the user only decides whether or not to purchase the product by seeing the prices presented by the product suppliers, and cannot present his/her desired purchasing price.

### SUMMARY OF THE INVENTION

Accordingly, it is a general object of the present invention to provide a price information mediating method which can solve the problems described above.

It is another and more specific object of the present invention to provide a method of offering a service for mediating a desired selling price of the product suppliers and a desired purchasing price of the user and a computer readable program in which program codes for implementing the above described method are stored.

In order to achieve the above objects, a price information mediating process for providing selling price information of at least one product supplier to at least one user is provided, which includes the steps of:

a) receiving product search conditions from the user;

b) retrieving a normal selling price of a desired product from storage means in accordance with the product search condition from the user, the storage means including normal selling price information which have been pre-registered by the product supplier;

c) sending the retrieved normal selling price to the user;

d) receiving a desired purchasing price presented by the user; and

e) sending the desired purchasing price to the product supplier.

According to the process of the present invention, since the product supplier can obtain the user's desired purchasing price, he will know the true value of the product considered by the user. Also, according to the process of the present invention, the product supplier only presents the selling price and does not necessarily need to present the allowable discount selling price. The product supplier then receives the desired purchasing price from the user. Therefore, it is possible to avoid loosing a selling opportunity without presenting unnecessary information. Further, if each of a plurality of product suppliers registers a selling price, the product suppliers can look up selling prices of each other. Thus, the product supplier can easily revise the selling price.

Also, according to the process of the present invention, the user can purchase a product at a desired price by showing his/her desired purchasing price.

### BRIEF DESCRIPTION OF THE DRAWINGS

FIG. 1 is a schematic diagram showing an information processing apparatus which may implement a process of the present invention.

FIG. 2 is a system block diagram showing the construction of an important part within the main body part of the computer system of FIG. 1.

FIG. 3 is a schematic diagram showing a system of the present invention.

FIG. 4 is a flow chart showing a flow of a product information registration process.

FIG. 5 is a flow chart showing a flow of a desired purchasing price registration process.

FIG. 6 is a flow chart showing a flow of selling price updating process.

FIG. 7 is a diagram showing an example of a product file, a user file and a desired purchasing price file.

FIG. 8 is a diagram showing an example of a search result display screen.

### DETAILED DESCRIPTION OF THE PREFERRED EMBODIMENTS

In the following, principles and embodiments of the present invention will be described with reference to the accompanying drawings.

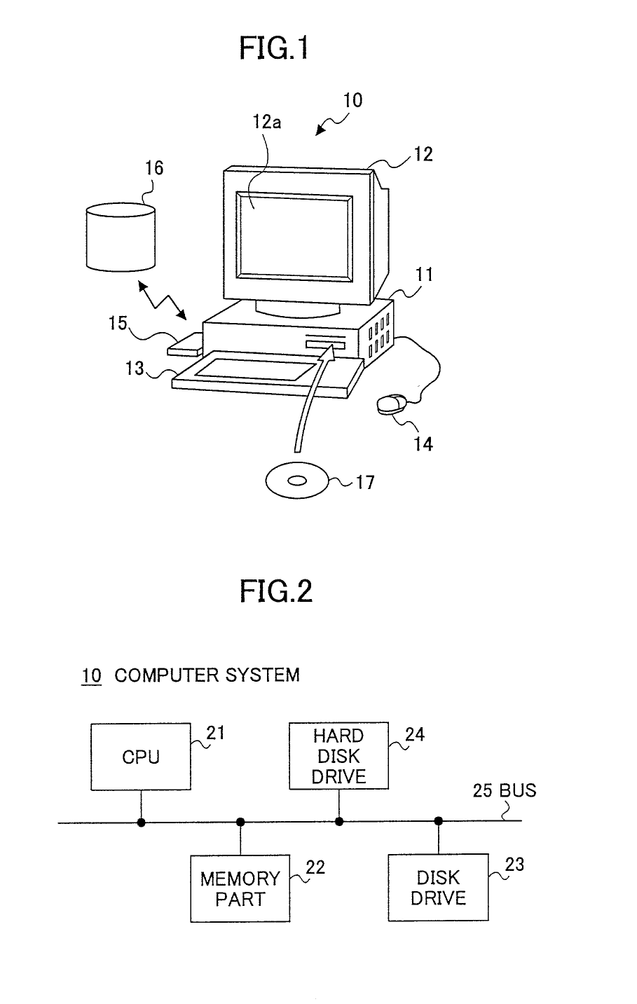

FIG. 1 is a schematic diagram showing an information processing apparatus which may implement a process of the present invention. A computer system shown in FIG. 1 is formed by a general computer system such as a personal computer (PC). The computer system 10 generally includes a main body part 11 which includes a CPU, a disk drive and the like, a display unit 12 which displays an image on a display screen 12a in response to an instruction to the computer system 10, a keyboard 13 which is used to input various kinds of information to the computer system 10, a mouse 14 which is used to make access to an external data base or the like and to download a program or the like stored in another computer system. A program which is stored in a portable recording medium such as a disk 17 or is downloaded from a recording medium 16 of another computer system by use of a communication unit such as the modem 15, is input to and is compiled in the computer system 10. This program includes a program for causing the CPU of the computer system 10 to carry out a process of mediating price information between at least one user and at least one product supplier.

FIG. 2 is a system block diagram showing the construction of an important part within the main body part 11 of the computer system 10 of FIG. 1. In FIG. 2, the main body part 11 generally includes a CPU 21, a memory part 22 including a RAM, ROM or the like, a disk drive 23 for the disk 17, and a hard disk drive 24 which are coupled via a bus 25. The display unit 12 and the like are coupled to the bus 25.

The construction of the computer system 10 is not limited to that shown in FIGS. 1 and 2 and various known constructions may be used in place thereof.

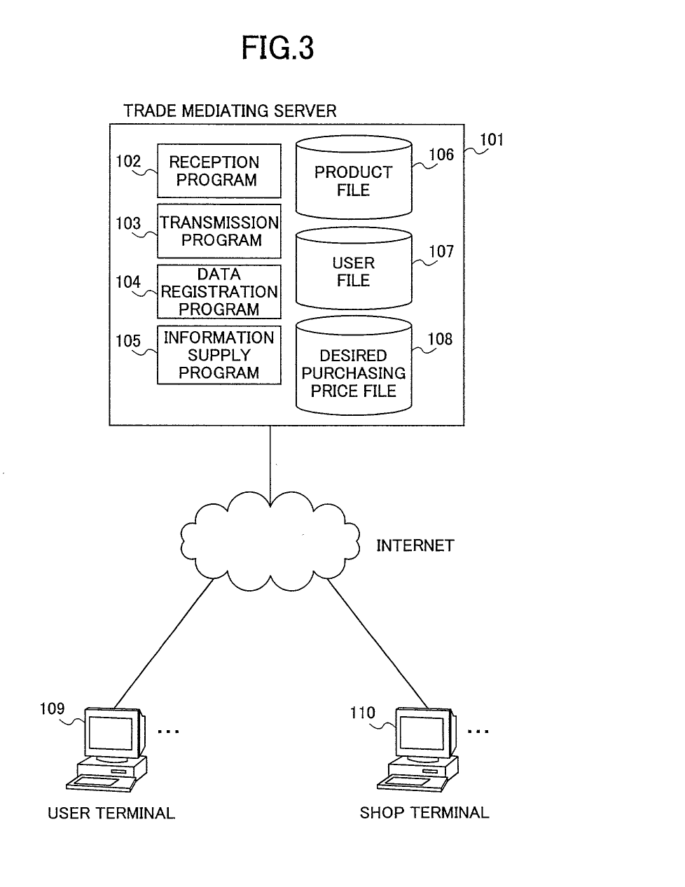

Referring to FIG. 3, general configuration of a system of a first embodiment of the present invention will be described. A trade mediating server 101 is a central system of the configuration of the present embodiment which runs a site managed by a product supplier (shop) or by a plurality of product suppliers under a joint investment contract.

The trade mediating server (site) 101 is connected to user terminals 109 via the Internet. The user terminal 109 may be any type of a device such as a personal computer (PC) or a portable telephone, as long as it is connectable to the Internet and can perform browsing on the Internet.

The trade mediating server 101 is also connected to shop terminals 110 via the Internet. Similarly, the shop terminal 110 may be any type of a device such as a personal computer or a portable telephone, as long as it is connectable to the Internet and can perform browsing on the Internet.

The trade mediating server 101 includes various programs 102 to 105 for realizing the trade mediating process of the present invention. The reception program 102 receives information from the user terminals 109 and from the shop terminals 110. The send program 103 sends information to the user terminals 109 and from the shop terminals 110. The data registration program 104 registers information received at the reception program 102. The information supply program 105 edits information to be supplied to the user terminals 109 and to the shop terminals 110. The trade mediating server 101 further includes a product file 106 for storing product information, a user file 107 for storing user information and a desired purchasing file 108 for storing desired purchasing prices of the user.

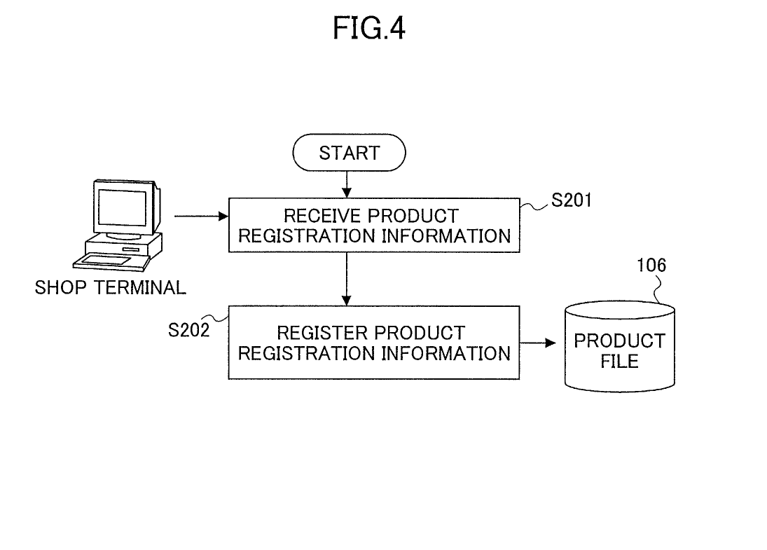

Referring now to FIG. 4, a process flow performed by the trade mediating server 101 for registering product information will be described. Firstly, the shop terminal 110 is operated by a person in charge, and is connected to the trade mediating server 101 via the Internet. Then, as step S201, the trade mediating server 101 receives product registration information from the shop terminals 110.

The product registration information may be an information including data items such as a shop name “A-Store”, a product name “PC C”, a selling price “100,000”, an e-mail address “MAIL@A.com”.

Here, further information such as an allowable discount selling price “90,000” may also be sent. The allowable discount selling price is a selling price set as a minimum limit price according to the user's wish, although the normal selling price is “100,000”.

When the above-mentioned product registration information is received, the trade mediating server 101 registers the product registration information in the product file 106, in step S202.

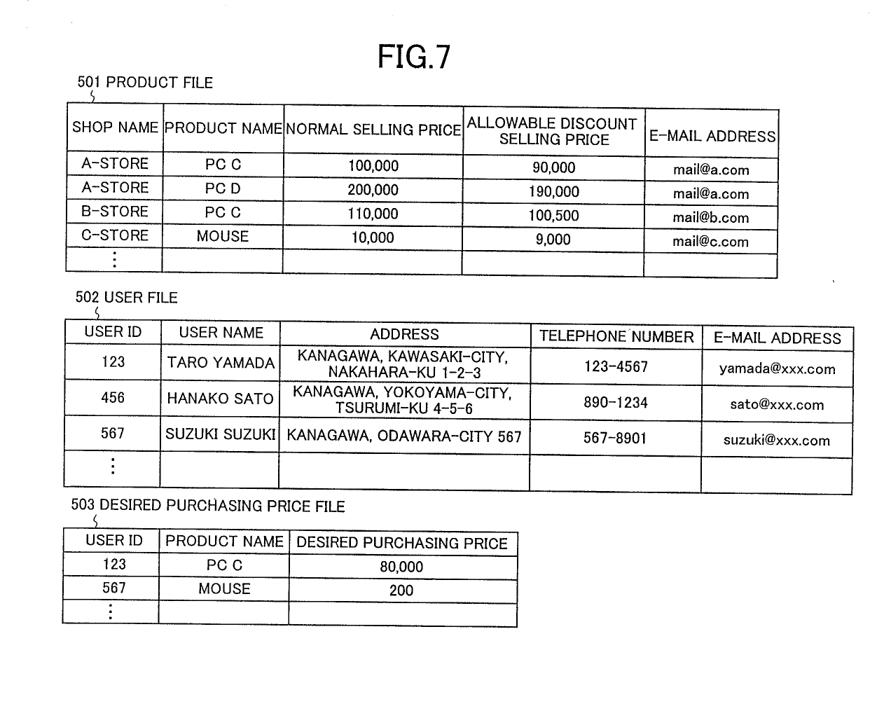

An example of information stored in the product file 106 is shown in FIG. 7 by a reference numeral 501. In this example, the product file 106 includes shop name, product name, selling price, allowable discount selling price, and e-mail address, such that a record registered in the step described above is stored as a first record in this example.

The product file 106 is referred from a WEB page which is open to the user terminals 109.

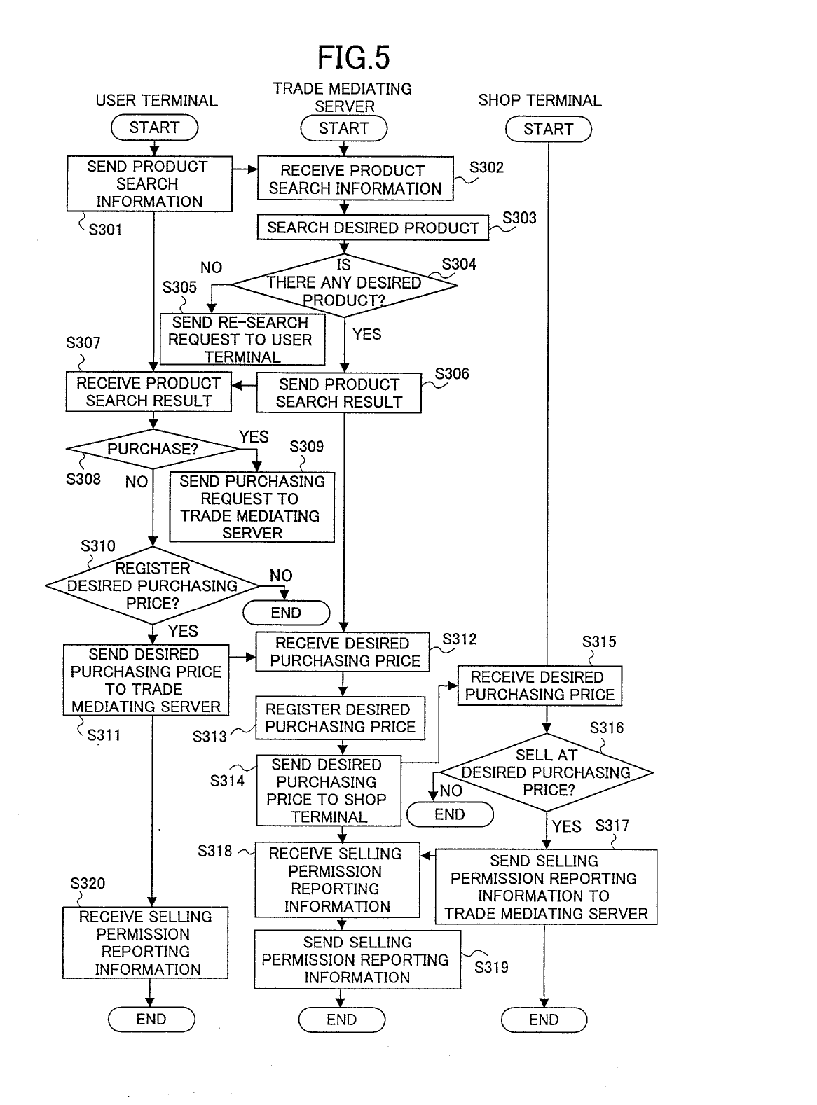

Referring now to FIG. 5, a process flow performed by the trade mediating server 101 for receiving desired purchasing price from the user terminals 109 will be described.

Firstly, the user terminal 109 is operated by the user and connected to the trade mediating server 101. Then, the product search information is sent to the trade mediating server 101, in step S301. The trade mediating server 101 receives the above-mentioned product search information in step S302.

For example, in this case, the user is Taro Yamada. The user information is pre-stored in the user file 107 of the trade mediating server 101.

An example of information stored in the user file 107 is shown in FIG. 7 by a reference numeral 502. In this example, the user file 107 includes user ID, user name, post office address, telephone number, and e-mail address, such that a record of the above-mentioned user Taro Yamada is stored as a first record in this example.

When a search key set by the user is “PC C”, the product file 106 is searched in step S303.

Then, it is determined whether a product matching the search key set by the user is stored in the product file 106, in step S304. If no matching record is found, a re-search request is sent to the user terminal 109, in step S305. In this case, since the search key is “PC C”, the product file 106 is searched for a record having product name “PC C”.

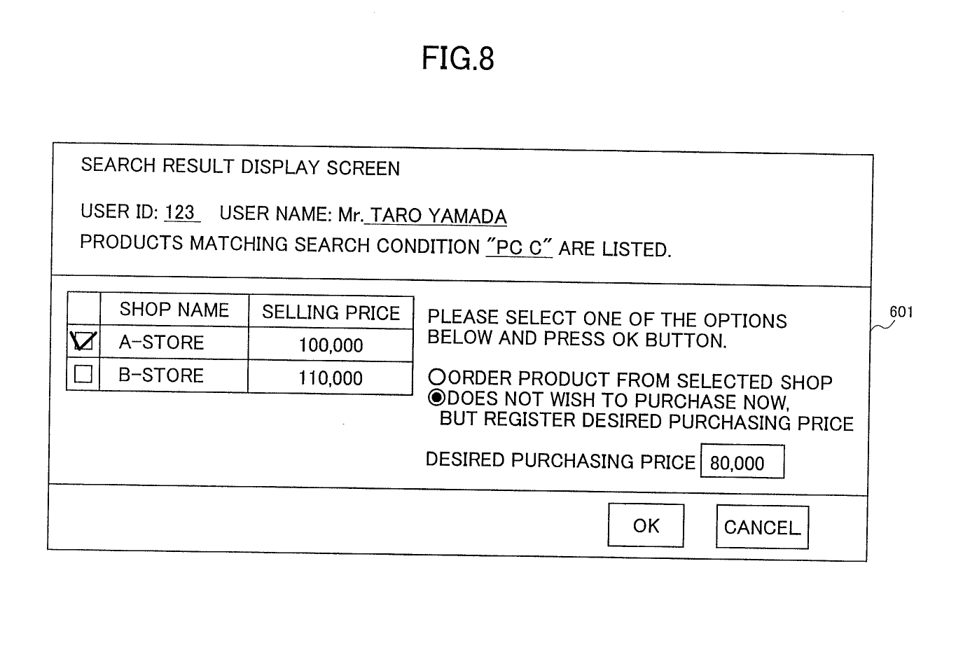

The result shows that two records matches the search key, which are in this case a first record “A-Store” and a third record “B-Store”. Based on information of these two records, a screen 601 shown in FIG. 8 is sent to the user terminal, in step S306.

FIG. 8 shows a search result display screen 601 in which user ID “123”, user name “Taro Yamada” and search condition “PC C” are indicated in a header part of the screen. Also, a search result including shop name and selling price are indicated in a body part of the screen.

When the user receives the search result display screen 601 in step S307, when the user decides to makes a purchase from one of the product suppliers displayed in step S308, the user selects a product supplier to make a purchase from the product suppliers displayed in the search result display screen 601 and clicks on a check box indicated on the left of the product supplier to be selected.

Then, the user clicks on a radio button corresponding to “Order a product from a selected product supplier”. Then, when an OK button provided at a tail part of the search result display screen 601 is pressed down, a purchase request is sent to the trade mediating server 101, in step S309.

If there is no product supplier presenting the selling price meeting the user's desired purchasing price in step S308, the process proceeds to step S310 to determine whether to register the desired purchasing price. If the user gives up to purchase the product, a Cancel button provided at the tail part of the search result display screen 601 is pressed down, and the process ends.

In step S310, if the user decides not to give up purchasing the product but to register the desired purchasing price, the user clicks on a radio button on the search result display screen 601, which is labeled “Does not wish to purchase now, but resister desired purchasing price”. Then, the user inputs a price at which he/she wishes to purchase the product in an input box “Desired purchasing price” provided underneath. Then, when the OK button at the tail part of the search result display screen 601 is pressed down, the desired purchasing price is sent to the trade mediating server 101 in step S311.

The trade mediating server 101 receives the desired purchasing price in step S312, and stores the user's desired purchasing price in the desired purchasing price file 108 in step S313.

An example of information stored in the desired purchasing price file 108 is shown in FIG. 7 by a reference numeral 503. In this example, the desired purchasing price file 108 includes user ID, product name and desired purchasing price, such that a record registered in the step described above is stored as a first record in this example.

Then, the trade mediating server 101 transmits information of the above-mentioned record to the shop terminal 110 in step S314. This information may be sent to all shop terminals registered to the trade mediating server 101 or may be sent selectively to shop terminals of the product suppliers wherefrom the desired product is available.

Further, the information need not be sent to all shop terminals, but may be selectively sent to shop terminals satisfying a certain condition. For example, the “allowable discount selling price” of the product file 106 is looked up so as to transmit information of the desired purchasing price only to those product suppliers where the registered “allowable discount selling price” is less than the desired purchasing price registered by the user.

In this manner, there is an advantageous effect that information which is not required at the product supplier, for example information including a too low desired purchasing price which has been maliciously input, can be prevented from being sent.

Information to be sent includes, for example, product name “PC C” and desired purchasing price “80,000”. The shop terminal 110 receives the desired purchasing price in step S315.

When this desired purchasing price information is received, in step S316, the person in charge at the product supplier makes a decision whether the product may be sold at the desired purchasing price. If the product cannot be sold at the desired purchasing price, no response is sent back. If the product can be sold at the desired purchasing price, a selling permission reporting information is sent in step S317. In this case, the reporting information includes data such as product name “PC C” and selling permission price “80,000”.

The trade mediating server 101 receives the selling permission reporting information in step S318, and transfers the selling permission reporting information to the user terminal 109 in step S319. In this case, a destination of reporting information is obtained by searching the desired purchasing price file 503 using the product name “PC C” included in the selling permission reporting information received at the shop terminal 110 and obtaining the user ID “123”.

Then, the user file 502 is searched using the above-mentioned user ID “123”, such that user name “Taro Yamada” and e-mail address “Yamada@xxx.com” are obtained. These data are used as the destination of reporting information, and the selling permission reporting information is sent to this e-mail address.

In step S320, the user receives the selling permission reporting information from the trade mediating server 101 and, for example, transmits a purchasing request to an e-mail address of the shop terminal described in that reporting information, in order to purchase the product at the desired purchasing price.

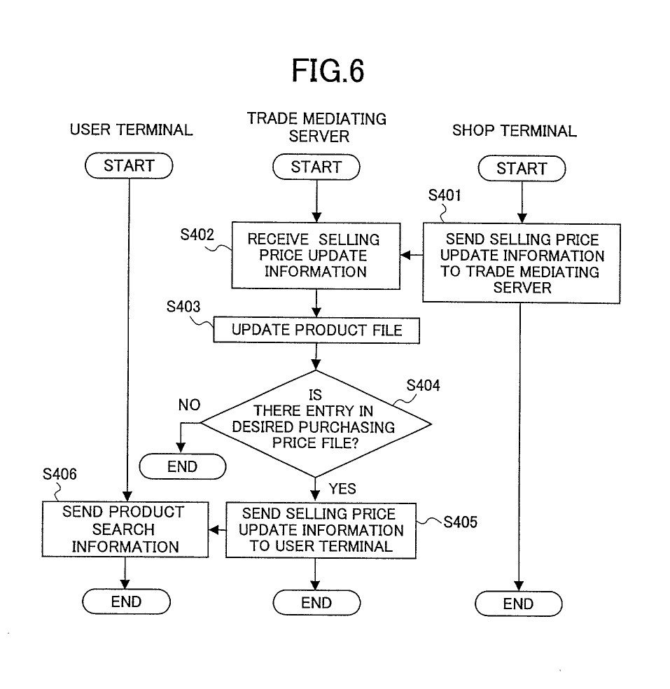

Next, referring to FIG. 6, a process flow performed by the trade mediating server 101 based on selling price update information from the shop terminals 110 will be described.

Firstly, the shop terminal 110 transmits the selling price update information to the selling mediating server 101. For example, when C-Store having product name “mouse” registered at a fourth record of the product file 501 updates the selling price and the allowable discount selling price, a selling price update information including shop name “C-Store”, product name “mouse”, selling price “500” and allowable discount selling price “200” is sent.

In step S402, the trade mediating server 101 receives the above-mentioned selling price update information. Then, in step S403 searches the product file 501 using shop name “C-Store” and product name “mouse” of the received selling price update information as search keys.

Then the selling price and the allowable discount selling price of the matching record are updated according to the received information. The updated record includes shop name “C-Store”, product name “mouse”, selling price “500”, allowable discount selling price “200” and e-mail address “mail@C.com”.

The trade mediating server 101 having updated the product file 501 in step S403 searches the desired purchasing price file 108 to examine whether there is any user who has registered the desired purchasing price of the above-mentioned updated product, in step S404.

When there is no record matching the desired purchasing price file 108, no particular action is taken.

In this case, it can be seen that in the desired purchasing price file 503, a user having user ID “567” has registered desired purchasing price “200” for the product name “mouse”.

It can be seen that the user initially wished to purchase the mouse at 200 yen, but the user has only registered the desired purchasing price since no product supplier was selling the mouse at that price. Then, due to the recent price updated by C-Store, the mouse is now available at the desired purchasing price presented by the user.

Then, the trade mediating server 101 transmits the selling price update information to the user terminal 109 in step S405. In this case, the destination of reporting information is obtained by searching the user file 502 using user ID “567” of the desired purchasing price file and extracting user name “Suzuki Suzuki” and obtain e-mail address “suzuki@xxx.com”. This information is used as the destination of reporting information, and the selling price update information is sent to this e-mail address.

In step S406, the user terminal receives the selling price update information from the trade mediating server 101 and send a purchasing request to an e-mail address of the shop terminal described in that reporting information, so that the user can make purchase at the desired purchasing price.

Further, the present invention is not limited to these embodiments, and variations and modifications may be made without departing from the scope of the present invention.

The present application is based on Japanese priority application No. 2001-102265 filed on Mar. 30, 2001, the entire contents of which are hereby incorporated by reference.

What is claimed is:

1. A price information mediating process for providing selling price information of at least one product supplier to at least one user: said process comprising the steps of:
a) receiving product search conditions from said user;
b) retrieving a normal selling price of a desired product from storage means in accordance with said product search condition from said user, said storage means including normal selling price information which have been pre-registered by said product supplier;
c) sending said retrieved normal selling price to said user;
d) receiving a desired purchasing price presented by said user; and
e) sending said desired purchasing price to said product supplier.

2. A price information mediating process for providing selling price information of at least one product supplier to at least one user: said process comprising the steps of:
a) receiving product search conditions from said user;
b) retrieving a normal selling price of a desired product from storage means in accordance with said product search condition from said user, said storage means including normal selling price information and allowable discount selling price corresponding to said normal selling price which have been pre-registered by said product supplier;
c) sending said retrieved normal selling price to said user;
d) receiving a desired purchasing price presented by said user; and
e) sending said desired purchasing price to said product supplier if said desired purchase price is greater than said allowable discount selling price.

3. A price information mediating process for providing selling price information of at least one product supplier to at least one user: said process comprising the steps of:
a) receiving product search conditions from said user;
b) retrieving a normal selling price of a desired product from first storage means in accordance with said product search condition from said user, said first storage means including normal selling price information which have been pre-registered by said product supplier;
c) sending said retrieved normal selling price to said user;
d) receiving a desired purchasing price presented by said user;
e) storing said desired purchasing price in second storage means;
f) receiving a request for updating said normal selling price stored in said first storage means; and
g) reporting to said user in case where said normal selling price takes a value less than said desired purchasing price stored in said second storage means as a result of said update request.

4. A computer readable medium storing program code for causing a computer to mediate price information between at least one user and at least one product supplier, said computer readable medium comprising:
first program code means for receiving product search conditions from said user;
second program code means for retrieving a normal selling price of a desired product from storage means in accordance with said product search condition from said user, said storage means including normal selling price information which have been pre-registered by said product supplier;
third program code means for sending said retrieved normal selling price to said user;
fourth program code means for receiving a desired purchasing price presented by said user; and
fifth program code means for sending said desired purchasing price to said product supplier.

5. A computer readable medium storing program code for causing a computer to mediate price information between at least one user and at least one product supplier, said computer readable medium comprising:
first program code means for receiving product search conditions from said user;
second program code means for retrieving a normal selling price of a desired product from storage means in accordance with said product search condition from said user, said storage means including normal selling price information and allowable discount selling price corresponding to said normal selling price which have been pre-registered by said product supplier;
third program code means for sending said retrieved normal selling price to said user;
fourth program code means for receiving a desired purchasing price presented by said user; and
fifth program code means for sending said desired purchasing price to said product supplier if said desired purchase price is greater than said allowable discount selling price.

6. A computer readable medium storing program code for causing a computer to mediate price information between at least one user and at least one product supplier, said computer readable medium comprising:
first program code means for receiving product search conditions from said user;
second program code means for retrieving a normal selling price of a desired product from first storage means in accordance with said product search condition from said user, said first storage means including normal selling price information which have been pre-registered by said product supplier;
third program code means for sending said retrieved normal selling price to said user;
fourth program code means for receiving a desired purchasing price presented by said user;
fifth program code means for storing said desired purchasing price in second storage means;
sixth program code means for receiving a request for updating said normal selling price stored in said first storage means; and
seventh program code means for reporting to said user in case where said normal selling price takes a value less than said desired purchasing price stored in said second storage means as a result of said update request.

7. A server for mediating price information between at least one product supplier and at least one user via a network, comprising:
first receiving means for receiving product search conditions from said user;
retrieving means for retrieving a normal selling price of a desired product from storage means in accordance part said product search condition from said user, said storage means including normal selling price information which have been pre-registered by said product supplier;
first sending means for sending said retrieved normal selling price to said user;
second receiving means for receiving a desired purchasing price presented by said user; and
second sending means for sending said desired purchasing price to said product supplier.

8. The server as claimed in claim 7, wherein said storage means also stores allowable discount selling price corresponding to said normal selling price which have been pre-registered by said product supplier, said second sending means determines whether said desired purchasing price is greater than said allowable discount selling price and sends said desired purchasing price to said product supplier when said second sending means determines that said desired purchasing price is greater than said allowable discount selling price.

9. The server as claimed in claim 7, further comprising:
third receiving means for receiving a request for updating said normal selling price stored in said storage means; and
reporting means for reporting to said user in case where said normal selling price takes a value less than said desired purchasing price stored in said storage means as a result of said update request.

10. The server as claimed in claim 7, further comprising:
fourth receiving means for receiving selling permission reporting information from the shop terminal; and
third sending means for sending said selling permission reporting information to said user terminal.
